(19) United States
(12) Patent Application Publication
(10) Pub. No.: US 2024/0147252 A1
(43) Pub. Date: May 2, 2024

(54) METHOD FOR EVALUATING THE DEPLOYMENT OF A CANDIDATE CONFIGURATION OF A RADIO ACCESS EQUIPMENT OF A TELECOMMUNICATIONS NETWORK, THE CORRESPONDING DEVICE, MANAGEMENT SYSTEM AND COMPUTER PROGRAM

(71) Applicant: Orange, Issy-les-Moulineaux (FR)

(72) Inventors: Danny QIU, CHATILLON CEDEX (FR); Maxence LAVERGNE, CHATILLON CEDEX (FR); Alassane SAMBA, CHATILLON CEDEX (FR); Yvon GOURHANT, CHATILLON CEDEX (FR)

(21) Appl. No.: 18/496,710

(22) Filed: Oct. 27, 2023

(30) Foreign Application Priority Data
Oct. 28, 2022 (FR) 2211262

(51) Int. Cl. H04W 16/18; H04W 24/10

(52) U.S. Cl. CPC H04W 16/18; H04W 24/10; G06F 16/29

(57) ABSTRACT

A method for evaluating a deployment of a candidate configuration, of radio access equipment of a communication network at a location including: obtaining historical data relating to the network, the historical data comprising topographical information relating to radio access equipment existing in a geographical area before deployment of the candidate configuration at the location level and measurements of one performance indicator of the communication network over an elapsed time period; and predicting a variation of the performance indicator of the communication network, induced by the deployment, the variation being predicted based on the historical network data and topographical information relating to the candidate configuration, and from a previously-learned prediction model, the prediction model being implemented by an artificial intelligence module configured to receive as input data the historical network data and the topographical information of the candidate configuration and to produce as output data the variation of the performance indicator.

### CROSS-REFERENCE TO RELATED APPLICATIONS

This application claims foreign priority to French Patent Application No. 2211262, entitled “METHOD FOR EVALUATING THE DEPLOYMENT OF A CANDIDATE CONFIGURATION OF A RADIO ACCESS EQUIPMENT OF A TELECOMMUNICATIONS NETWORK, THE CORRESPONDING DEVICE, MANAGEMENT SYSTEM AND COMPUTER PROGRAM” and filed Oct. 28, 2022, the content of which is incorporated by reference in its entirety.

### BACKGROUND

### Field

The development relates to the telecommunications field.

In particular, the development relates to the deployment of new radio resources at the level of radio access equipment of a telecommunications network.

It applies in particular, yet not exclusively, to a mobile telecommunications network whose architecture complies with the 3GPP (standing for “Third Generation Partnership Project”) standard, in one of its current or future versions.

### Description of the Related Technology

In order to improve the performances and availability of a mobile telecommunications network, in particular to limit congestion situations and, more generally, improve the quality of service of users, an operator is regularly required to deploy new radio resources in the network. For example, such a deployment comprises the installation of new radio access equipment on a new geographical site, which will allow increasing the capacities of the network in the considered geographical area.

Yet, in urban areas, which are already very dense, it is becoming difficult to deploy new sites and an alternative solution consists increasingly in deploying a new configuration of existing radio equipment, i.e. commissioning new transmission/reception frequencies (or radio cells), or even new transmission/reception sectors for an existing frequency.

Before deciding to incur investment costs and effectively proceed with the deployment of this new configuration in the field, the operator of the network would need to assess the impact of such an evolution of its network on its performances.

In this respect, according to the known technique, a software tool called “Meta Network Insights” (https://www.facebook.com/connectivity/solutions/network-insights) allows observing the variation in the quality of service perceived by users of the Facebook mobile application before and after a deployment of a new radio configuration. A drawback of this tool is that it only observes real facts, but does not provide any decision support prior to the update of an access network architecture.

The development is intended to improve the situation.

### SUMMARY

To this end, the development provides a method for evaluating a deployment of a candidate configuration, of at least one radio access equipment of a communication network at a location, so-called the site, in a geographical area comprising: obtaining network data, so-called the historical data, relating to said network in the geographical area, said historical data comprising at least topographical information relating to radio access equipment existing in said geographical area before deployment of the candidate configuration at the location level, so-called the sites, and measurements of at least one performance indicator of the communication network in the geographical area over an elapsed time period, so-called the reference period; and predicting a variation of said at least one performance indicator of the communication network in said geographical area, induced by said deployment, said variation being predicted at least based on the historical network data and topographical information relating to the candidate configuration, and from a previously learned prediction model, said prediction model being implemented by an artificial intelligence module configured to receive as input data the historical network data and the topographical information of the candidate configuration and to produce as output data the variation of said at least one performance indicator.

Thus, the development provides an entirely new and inventive approach for planning a deployment of new radio access equipment or a new configuration of radio access equipment already existing in a telecommunications network, which consists in evaluating the impact of an evolution of the network, using the prediction of at least one performance indicator of the communication network in said geographical area, induced by said deployment, based on a prediction model implemented by an artificial intelligence module. One advantage of using an artificial intelligence module is to profit from its processing power and integration of a very large amount of data and its ability, once trained, to produce reliable, accurate and reproducible results. According to a first embodiment of the development, the prediction model is configured to predict the values of at least one performance indicator after deployment of the candidate configuration, which are then used to determine a variation of this indicator by comparison with the historical values of the performance indicator (read during the reference period, before deployment of the candidate configuration), or according to a second embodiment, the prediction model directly produces a variation or rate of variation in the values of this performance indicator between before and after deployment.

In a particular embodiment, the method may comprise determining a metric for evaluating the candidate configuration, or score, based on said variation of a performance indicator of the network and at least one prioritization criterion associated with a metric representative of an evolution of a performance of the network induced by said deployment, the score being obtained by applying said at least one prioritization criterion to the predicted variation of the performance indicator.

This determination of a metric representative of an evolution of the performances of the network induced by this deployment in a geographical area encompassing the location of the site, according to at least one prioritization criterion, allows translating a policy of the operator of the network in terms of metrics.

For example, a prioritization criterion may consist in favoring a candidate configuration which has a positive impact on the performances of all of the cells of the considered site or, alternatively, on the 800 MHz frequency band alone. For example, the policy of an operator may be to activate a deployment on a site, when the evolution of the performances generated by the candidate deployment is positive for all radio frequencies or, alternatively, positive for the 800 MHz frequency band alone.

According to yet another aspect, the method further comprises building, based on the historical network data, a data table, so-called table of performances of the network in the geographical area; building an input data table intended to be presented to said artificial intelligence module, based on the performance table, the topographical data relating to the candidate configuration and historical external data including demographic and map data of the geographical area an output data table being produced by the artificial intelligence module, comprising at least predicted values of the variation of said at least one performance indicator of the site induced by the deployment of the candidate configuration.

One advantage is to provide the artificial intelligence module with a merged table of input data of various types from which it will solve a regression problem to provide at least one continuous value per performance indicator.

According to another aspect of the development, the method comprises: obtaining the historical external data; and modeling a geographical area served by said at least one site, so-called the radio coverage area, based on said historical network data and the historical external data, the radio coverage area of said at least one site being taken into account for the determination (24) of an evaluation of the deployment of the candidate configuration.

An advantage of enriching the data taken into account for the evaluation and thus improving this evaluation.

According to yet another aspect of the development, the method comprises building, based on the historical external data obtained in the radio coverage area, a second data table, so-called the data table of the urban fabric of the coverage area of the site, said input data table being built by merging the performance table, the topographic data relating to the candidate configuration and the urban fabric table.

In this manner, different types of information are combined in one single input data table, which facilitates the use of the data for the evaluation.

According to another aspect of the development, the method comprises, in a prior phase: obtaining learning network data, relating to at least one site of a communication network in a geographical area, over an elapsed time period, so-called the learning period, during which at least one new configuration has been deployed on the at least one site, said learning network data comprising at least topographical information relating to a previous configuration and to the new configuration of said at least one site and measurements of at least one performance indicator of the site; building, based on the learning network data, a first data table, so-called the evolution table of the performances of the site before and after deployment of the at least one new configuration; obtaining external learning data including demographic and map data of the geographical area, for the learning period; modeling a geographical area of a geographical area served by said at least one site, so-called the learning radio coverage area, based on said learning network data; building, based on the external learning data in the learning radio coverage area, a second data table, so-called the learning urban fabric table of the coverage area of the site; building a first set of learning data by merging the evolution table of the performances and the learning urban fabric table; and training the artificial intelligence module based on the first learning set, said prediction model being obtained.

One advantage of the development is that it is based on enriched learning data, which cross-reference different types of information.

Taking into account information relating to the urban fabric in the coverage area of the sites in the geographical area from which the learning data are derived, allows improving the accuracy of the prediction model.

Another advantage is that they include actual deployments of new configurations for the considered network. The learning network data may be collected by the operator of the communication network for which a deployment of new resources is considered or derived from another network.

According to yet another aspect of the development, the learning period comprises at least one first comparison period, one deployment period subsequent to the first period and a second comparison period subsequent to the deployment period and in that building of the performance evolution table comprises a comparison of the values of said at least one performance indicator obtained during the first and second comparison periods.

One advantage is to measure the real impact of a new configuration deployed during the learning period on the performances of a telecommunications network and to use this knowledge to automatically predict that of a candidate configuration for a given site.

Advantageously, to avoid seasonality effects, sufficiently long comparison time periods are considered, for example one year each and the indicator values of a given month M of the first period are compared with the same month of the second period. This avoids introducing biases due to seasonal demographic or socio-economic events, like for example the high geographical mobility of users during the summer period.

According to another aspect of the development, the method comprises: building a second set of learning data, so-called the control set, obtained based on learning network data for at least one other site in the network or another network belonging to the same geographical area and for which no new configuration has been deployed during the learning period, and said artificial intelligence module is trained based on the first and second learning data sets.

One advantage of using a control set is to avoid biases due to a “natural” evolution of the network, related in particular to an evolution in the number of subscribers to this network.

According to yet another aspect of the development, the method is implemented for a plurality of candidate configurations in said communication network (and it further comprises ranking of the plurality of deployments according to the determined scores.

With the development, several projects for deploying candidate configurations on one or more site(s) may be evaluated and compared.

In this case, the artificial intelligence module is configured to solve a multi-target regression problem and predict a continuous value per performance indicator for several candidate configurations (and therefore several frequency bands or several sectors).

Advantageously, an arbitration is then carried out based on the scores obtained by the various projects. The solution of the development could be exploited by technical and/or geomarketing teams of a telecommunications network operator to optimally plan the new deployments to be implemented in its network.

One could also consider putting several candidate configurations in competition for the same site.

According to yet another aspect of the development, said site comprising at least one radio cell configured to transmit and receive radio waves at a given frequency in at least one given sector, said at least one candidate configuration belongs to a group comprising at least: the addition of a radio cell associated with a frequency different from the existing frequencies on said site; the addition of a transmission sector to an existing radio cell, the replacement of an existing radio cell associated with a first frequency with a new radio cell associated with a second frequency distinct from the first, the replacement of a radio cell associated with a first technology with a radio cell associated with a second technology.

The candidate configurations for a given site may be of various types, allowing the deployment of new radio resources to be adjusted to the specific needs of a geographical area. These may include adding new sectors to an existing radio cell, a new radio cell, replacing an older technology radio cell with a newer technology radio cell, etc.

The development also relates to a device for evaluating a deployment of a candidate configuration, of at least one radio access equipment of a communication network at a location, so-called the site, in a geographical area, configured to implement: obtaining network data, so-called the historical data, relating to said network in the geographical area, said historical data comprising at least topographical information relating to radio access equipment existing in said geographical area before deployment of the candidate configuration at the location level, so-called the sites, and measurements of at least one performance indicator of the communication network in the geographical area over an elapsed time period, so-called the reference period; and determining a metric for evaluating the candidate configuration, or score, based on a variation in said at least one performance indicator of the communication network in said geographical area, induced by said deployment and at least one prioritization criterion associated with a metric representative of an evolution of a performance induced of the network by said deployment, said variation being predicted at least based on the historical network data and topographical information relating to the candidate configuration.

Advantageously, said device is configured to implement the steps of the method for evaluating the deployment of a candidate configuration as described before.

Advantageously, said device is integrated into a management system of a telecommunications network.

The system has at least the same advantages as those conferred by the aforementioned evaluation method.

The development also relates to a computer program product comprising program code instructions for the implementation of the evaluation method as described before, when it is executed by a processor.

A program may use any programming language, and be in the form of a source code, an object code, or an intermediate code between a source code and an object code, such as in a partially compiled form, or in any other desirable form.

The development also relates to a computer-readable recording medium on which a computer program is recorded comprising program code instructions for the execution of the steps of the method according to the development as described hereinabove.

Such a recording media may consist of any entity or device capable of storing the program. For example, the medium may include a storage means, such as a ROM, for example a CD-ROM or a ROM of a microelectronics circuit, or a magnetic storage means, for example a mobile medium (memory card) or a hard disk or an SSD.

Besides, such a storage medium may be a transmissible medium such as an electrical or optical signal, which could be conveyed via an electrical or optical cable, by radio waves or by other means, so that the computer program contained therein is remotely executable. In particular, the program according to the development may be downloaded on a network, for example the Internet network.

Alternatively, the recording medium may be an integrated circuit in which the program is incorporated, the circuit being adapted to execute or to be used in the execution of the aforementioned method.

According to one embodiment, the present technique is implemented by means of software and/or hardware components. With this in mind, the term “module” may correspond in this document to a software component, a hardware component or a set of hardware and software components.

A software component corresponds to one or more computer program(s), one or more subprogram(s) of a program, or more generally to any element of a program or of a software able to implement a function or a set of functions, according to what is described hereinbelow for the considered module. Such a software component is executed by a data processor of a physical entity (terminal, server, gateway, set-top-box, router, etc.) and is likely to access the hardware resources of this physical entity (memories, recording media, communication bus, input/output electronic cards, user interfaces, etc.). In the following, by resources, it should be understood all sets of hardware and/or software elements supporting a function or a service, whether individual or combined.

In the same manner, a hardware component corresponds to any element of a hardware set (or hardware) able to implement a function or a set of functions, according to what is described hereinbelow for the considered module. It may consist of a hardware component that is programmable or with an integrated processor for software execution, for example an integrated circuit, a chip card, a memory card, an electronic card for the execution of a firmware, etc.

Of course, each component of the previously-described system implements its own software modules.

The different above-mentioned embodiments can be combined together for the implementation of the present technique.

### BRIEF DESCRIPTION OF THE DRAWINGS

Other features and advantages of the present development will appear from the description made below, with reference to the appended drawings illustrating a non-limiting exemplary embodiment. In the figures:

FIG. 1 schematically illustrates an example of an architecture of a management system of a mobile telecommunications network implemented according to an embodiment of the development;

FIG. 2 describes in the form of a flowchart the steps of a method for evaluating a deployment of a candidate configuration of a site in a telecommunications network, according to an embodiment of the development;

FIG. 3 details a learning phase of a prediction model implemented by the evaluation method according to an embodiment of the development;

FIG. 4 illustrates an example of a learning time period during which the learning data are obtained, comprising a deployment sub-period;

FIG. 5 illustrates an example of an urban fabric map obtained by merging a map of the radio coverage areas associated with the sites of a communication network and topographic and demographic data in a geographical area;

FIG. 6 schematically illustrates the obtainment of sub-polygons for the sectors of a site from the Voronoi polygon of the site;

FIG. 7A schematically illustrates the learning phase of a prediction model implemented by an artificial intelligence module according to an embodiment of the development;

FIG. 7B schematically illustrates the test phase of a prediction model previously learned according to an embodiment of the development;

FIG. 8 schematically details the production phase of a prediction of a variation of at least one performance indicator of the communication network by the artificial intelligence module, induced by the deployment of the at least one candidate configuration, according to an embodiment of the development;

FIG. 9 schematically describes an example of application of the method for evaluating a new configuration of a site to arbitrate between several candidate configurations according to an embodiment of the development;

FIG. 10 schematically illustrates an example of ranking of the candidate configurations produced by the development according to this embodiment; and

FIG. 11 describes an example of a hardware structure of a device for evaluating at least one deployment of a candidate configuration according to the development.

### DETAILED DESCRIPTION OF CERTAIN ILLUSTRATIVE EMBODIMENTS

The principle of the development consists in evaluating a candidate deployment of new radio access resources of a communication network at a given geographical location, so-called the site, based on the prediction of an indicator of variation of the performances of the network induced by the candidate deployment based on historical data relating to the communication network in the geographical area and the determination of a score based on this indicator and based on one or more prioritization criterion/criteria.

The candidate deployment may involve the implantation of a new radio access equipment at a given geographical position or the commissioning of a new configuration on an already deployed radio access equipment. This new configuration may consist in adding a new radio cell or one or more new sector(s) to an already deployed radio cell. It may also comprise replacing a radio cell associated with a given technology with a radio cell associated with a newer technology.

The development applies to any type of communication network comprising one or more radio access network(s). It finds an advantageous application in a mobile telecommunications network whose architecture complies with the 3GPP standard in one of its current or future versions.

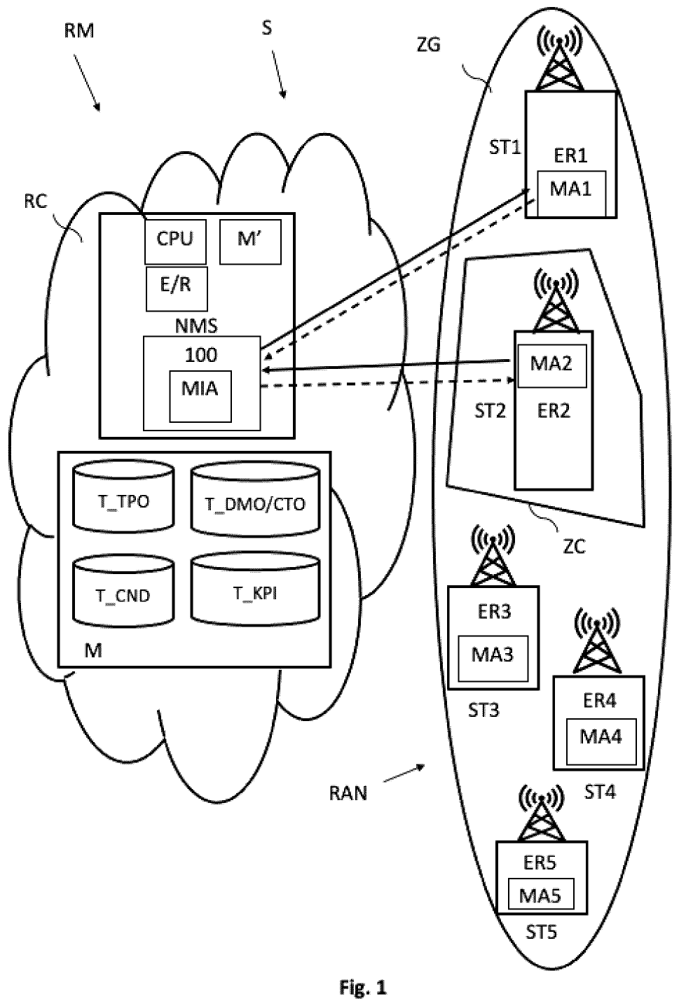

Referring to FIG. 1, a simplified example of an architecture of a mobile telecommunications network RM to which the development pertains is presented for illustration. It comprises a core network RC and a radio access network RAN. The radio access network comprises several pieces of radio access equipment ER1-ER5 located within a geographical area ZG. These include, for example, base stations equipped with one or more radio antenna(s) (not shown).

In the following, by coverage area, it should be understood a geographical area within which user terminals configured to connect to the mobile network RM can attach to the base station, i.e. they are within radio range of this base station and can communicate with it by radio. In FIG. 1, the coverage area ZC associated with the radio access equipment ER2 has been illustrated in the form of a polygon with reference to the Voronoi technique, known per se, to model such a coverage area.

The development applies to any type of mobile telecommunications network, the architecture of which complies, for example, with the 3GPP standard in one of its current or future versions.

In FIG. 1, the core network comprises a management equipment NMS (standing for “Network Management System”), configured to collect network performance measurement data of the data originating from management modules or agents MA1-MA5 (standing for “Management Agent”) placed at different positions in the radio access network RAN, for example at the sites of the radio access equipment ER1-ER5 and even integrated into this radio access equipment. In a way known per se, such equipment NMS generally provides functionalities, so-called FACPS, for monitoring the performances of the entire network (standing for “Fault, Configuration, Accounting, Performance, Security”).

FIG. 1 schematically illustrates an example of an architecture of a system S for the management of the communication network resources, according to an embodiment of the development. According to this embodiment of the development, the system S comprises the management equipment NMS and the management agents MAI-MAS.

According to the development, the system S also comprises a device 100 for evaluating a deployment of a candidate configuration of radio access equipment of the communication network RAN, configured to obtain data relating to said network in a geographical area, for example ZG, comprising the site of the radio access equipment, so-called the historical network data, comprising network data comprising at least topographical information relating to radio access equipment existing in said geographical area before the deployment of the candidate configuration, and measurements of at least one performance indicator of the communication network in the geographical area over an elapsed time period, so-called the reference period. The device 100 is further configured to determine an evaluation metric of the candidate deployment, or score, according to a variation of said at least one performance indicator of the communication network in said geographical area, induced by said candidate deployment and of at least one prioritization criterion associated with a metric representative of an evolution of a performance of the network induced by said deployment, said variation being predicted based on the historical data and topographical information relating to the candidate configuration.

Advantageously, the evaluation device 100 obtains the topographical information of the access network RAN from a data table T_TPO stored in the memory M or another memory of the core network RC. It obtains the measurements of performance indicators KPI of the radio access network RAN (at least in the geographical area ZG) from a data table T_KPI, stored in the memory M or in another memory of the core network RC. At least part of these have been collected beforehand by the management agents MA1-MA5. It is assumed that it obtains the topographical information relating to the candidate configuration of a data table T_CND stored in the memory M or in another memory of the core network RC. According to an embodiment of the development, it obtains data external to the network, or contextual, comprising at least demographic and map information of the geographical area ZG from a data table T_DMO, for example stored in the memory M of the core network RC. Of course, the development is not limited to this example of implementation, several memories and several data tables can be used to store the different information the deployment device 100 needs.

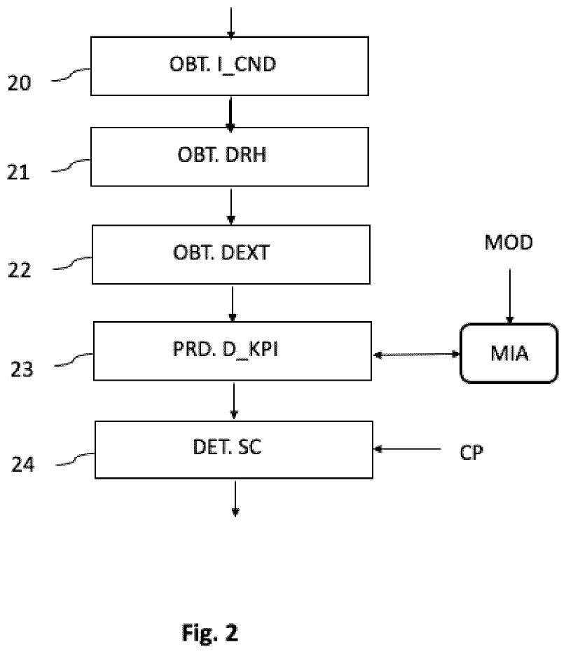

Thus, the device 100 implements the method for evaluating a deployment of a candidate configuration in a communication network according to the development which will be detailed hereinafter with reference to FIG. 2.

Advantageously, the management equipment NMS features the hardware structure of a computer and comprises a processor CPU, a memory M′ in which for example computer programs are stored, as well as a transmission/reception module E/R which enables it to communicate with other equipment of the network RC. Alternatively, the processing device 100 may be independent of the terminal piece of equipment 5, but connected to the latter via any link, wired or not. For example, it may be co-located with the management equipment NMS or integrated into another piece of equipment of the core network RC or in a specific entity of the core network RC. For example, it may be implemented as a virtualized function.

Referring to FIG. 2, an example of implementation of a method for evaluating a deployment of at least one new configuration in a telecommunications network, herein the mobile network RM, according to the development, is now presented in the form of a flowchart. This method is implemented by the aforementioned device 100.

In the following, these resources relate to radio wave transmission/reception equipment in one or more of the frequencies allocated to the mobile network RM. More specifically, by cell, it should be understood a piece of radio transmission/reception equipment comprising one or more antenna(s) configured to transmit and receive at one of these frequencies. For example, for the 4G standard, the transmission frequencies are 700 MHz, 800 MHz, 1,800 MHz, 2,100 MHz and 2,600 MHz. For a given cell, the antennas are deployed to transmit in different directions defined by an azimuth, each corresponding to a sector.

In general, by site, it should be understood a geographical location of one or more radio cell(s). All cells grouped on the same site ST1-ST5 forms radio access equipment such as those ER1-ER5 described with reference FIG. 1.

According to the development, in the broadest sense, by deployment of a new configuration of radio access resources means, it should be understood:
the deployment of one or more new radio cell(s) on an existing site,
the deployment of one or more new radio cell(s) at a new site,
the addition of one or more additional sector(s) to one or more existing radio cell(s),
the replacement of one or more existing radio cell(s) associated with a technology with one or more radio cell(s) associated with a more recent technology.

The term existing sector configuration or existing site configuration is generally used to refer to all sectors or all cell frequencies that are installed, i.e. already deployed, on a site. Similarly, a candidate configuration refers to all frequencies that are to be deployed on one or more sector(s) of an existing configuration of an existing site or on a new site.

In the following, the geographical area ZG refers to the area in which the deployment of the candidate configuration is considered. For example, it encompasses one or more district(s), one or more department(s), or an administrative region.

In 20, information relating to at least one candidate configuration is obtained. This consists of topological information of the candidate configuration, in terms of frequency/ies (or cells), azimuth(s) (or sectors) and technologies (3G, 4G, 5G, etc.). For example, this information is stored in the data table TCND. For example, these concern the site ST2.

In 21, historical information HRD relating to the radio access network RAN in the geographical area ZG comprising the site ST2 is obtained. This consist in part of time data available to the operator of the mobile network RM, which are reported by the radio access equipment ER1-ER5 and collected by the management agents MA1-MA5, and partly of static data relating to the existing topology/configuration of the radio access network RAN in the geographical area ZG.

The time data relating to the network in the geographical area include values of one or more performance indicators of the communication network over an elapsed time period, or reference period.

In the following, this concept of performance indicator refers to any relevant information for measuring a level of performances of the communications network in the geographical area served by the considered radio access equipment. Without loss of generality, this includes, for example, information relating to:
a downward communication data rate, from the access equipment to the terminal equipment;
a number of pieces of terminal equipment connected to the access equipment;
an overall volume of data traffic in the geographical area;
a level of usage of hardware or software resource units of the access equipment, for example frequency resource units PRB (standing for “Physical Resource Blocks”) by a base station of a mobile telecommunications network; or
a volume of data exchanged for a given type or class of service; or
a volume of energy resources consumed by the access equipment.

This is commonly referred to as a Key Performance Indicator KPI (or “Key Performance Indicator”). These are historical network data, in the sense that they have been collected over an elapsed time period, so-called the reference period, with a time granularity that could vary depending on needs: sub-hourly, hourly, daily. It should be noted that the reference period advantageously counts at least one year.

Static data includes topographical information of existing sites and provides information in particular on:
the geographical position of the cells,
their sector(s) with the associated azimuth(s),
the frequency band,
the technology,
the commissioning date,
etc.

In 22, information external DEXT to the mobile network and relating to a context of deployment of the radio access resources in the geographical area ZG is obtained. Typically, this consists of mapping, demographic and socio-economic external data. They describe the urban fabric in the vicinity of the site where the candidate deployment is considered. Indeed, the impact of the deployment of new cells on a given site strongly depends on human activity near this site. These data may be public or private. For example, the map data comes from a public database called “OpenStreetMap”, the demographic and socio-economic data are gridded data supplied by the French Insee and the data on population distribution come from a database called “Humanitarian Data Exchange” (supplied by Meta©).

In 23, a variation of at least one of said performance indicators DKPI as a result of the deployment is predicted in the geographical area ZG from the historical network data DRH, the external data DEXT and the topographical information ICND relating to the candidate configuration.

Advantageously, this prediction 23 is carried out by an artificial intelligence module MIA which implements a prediction model previously learned using learning data and a machine learning technique (“Machine Learning”). According to a first embodiment of the development, the prediction model MOD is configured to predict values of at least one performance indicator after deployment. Afterwards, the variation is obtained by comparing the predicted values with the historical values of the indicator(s). According to a second embodiment of the development, the variation of the indicator is directly predicted. An example of implementation will be detailed hereinafter.

In 24, an evaluation metric of the candidate configuration, or score SC, is determined, according to the predicted variation and at least one prioritization criterion CP. An embodiment will be detailed hereinafter.

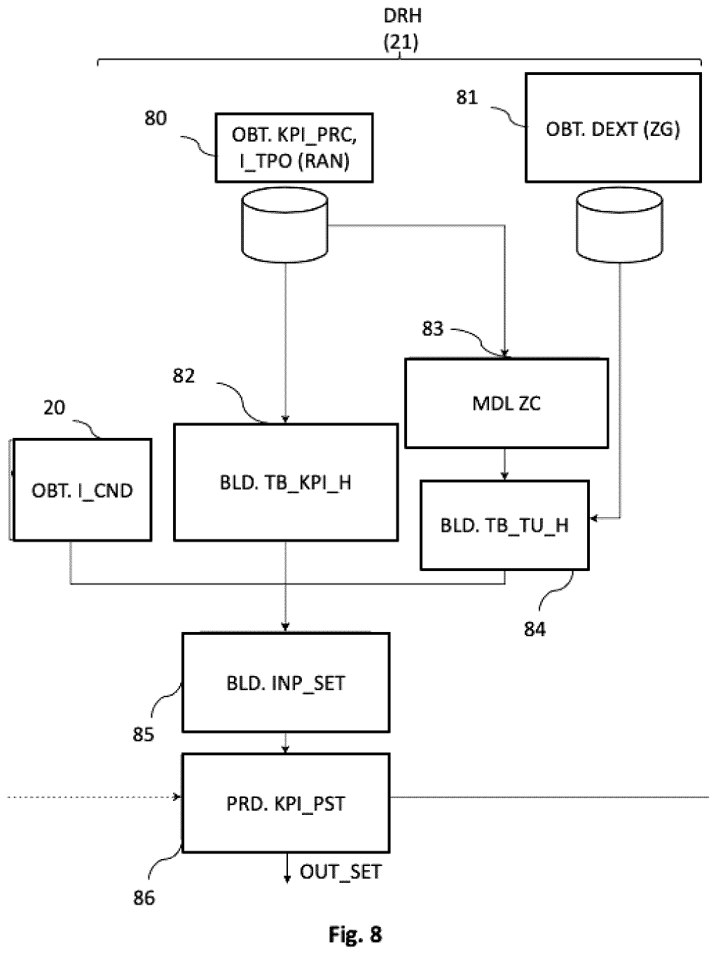

The evaluation method that has just been presented can advantageously be applied to arbitrate between several candidate configurations associated with one or more site(s) of the radio access network. In this case, the steps 20 to 23 that have just been implemented for each candidate configuration and the scores obtained for each of them are ranked so that a deployment decision could be made based on this ranking. An embodiment will be detailed with reference to FIG. 8.

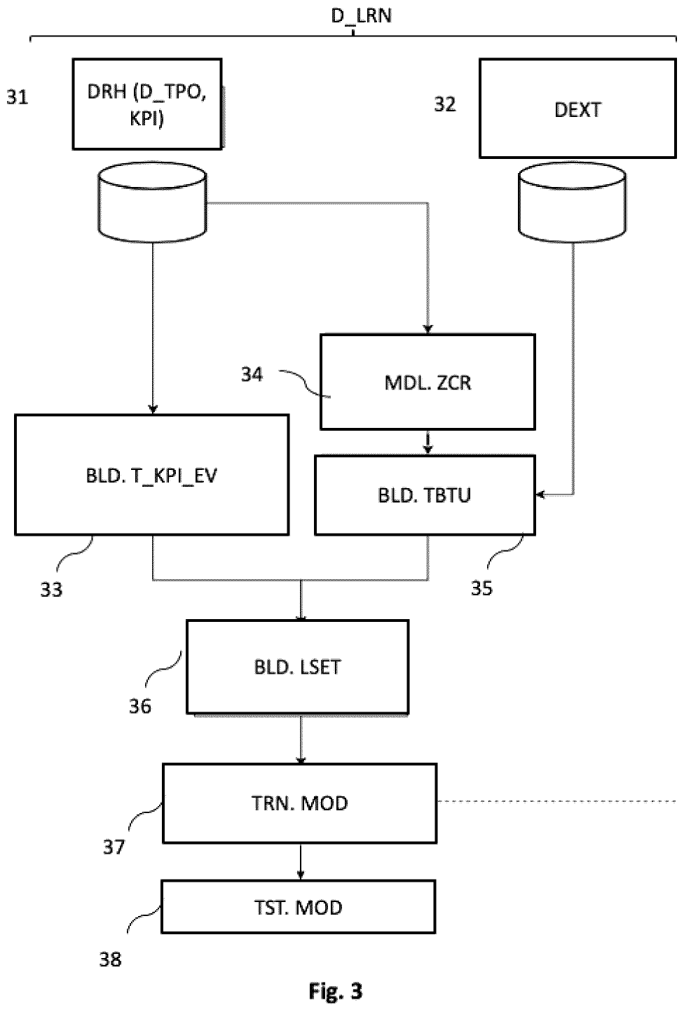

An exemplary implementation of a learning or training phase of the prediction model MOD is now described with reference to FIG. 3. This learning phase is prior to the implementation of the evaluation process described with reference to FIG. 2.

For this learning, a set of learning data D_LRN comprising historical data HRD relating to a mobile network over an elapsed time period, called the learning period, and external data DEXT relating to a context of that network in the considered geographical area, are considered. In this example, it is assumed that these are the same types of data as those previously described in connection with steps 21, 22 and 23 of FIG. 2. In particular, it is assumed that these are the same performance indicators KPIs. However, while it is generally the same mobile network for obvious practical reasons (the operator can use the data that it has collected by itself), data from another mobile network could be used. As regards the geographical area used for learning, it may coincide, or not, with the geographical area ZG in which the deployment is considered, but it is generally at least as large and possibly larger. For example, the geographical area used for learning includes one or more administrative region(s), and even a country.

Thus, the sites considered for learning may be identical or distinct from those concerned by the candidate configuration and the external data describing the urban fabric may not necessarily correspond to those of the geographical area considered for the deployment of the candidate configuration.

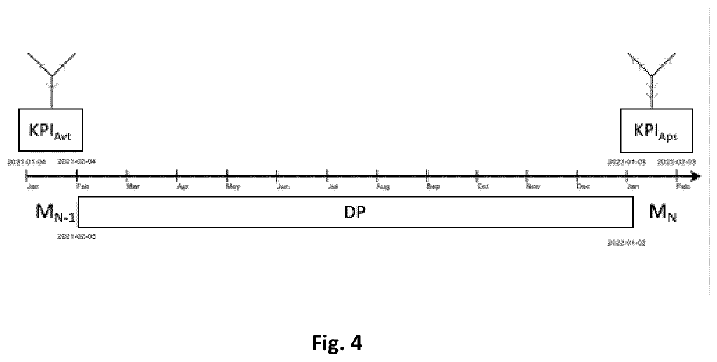

One advantage is that it will be possible to collect more learning data and give more genericity to the prediction model that will be obtained. An important characteristic of this set of learning data is that it must necessarily have been acquired over a time period including a deployment period, i.e. during which deployments of new configurations have taken place in the geographical area to which the learning data relates. In this manner, the learning data set includes performance indicator measurements before and after deployment of these new configurations. An example of a learning time period will be presented hereinafter with reference to FIG. 4.

In 33, a table of evolution data TB_KPI_EV of the sites of the considered radio access network during the considered learning period is built.

Creation of the table of evolution of the performances of the sites (or sectors) between before and after deployments

It is obtained by processing the time data (KPI) and the topographic data (D_TPO) of the mobile network in the considered geographical learning area. For example, one of the processing operations comprises an extraction of data concerning the sites of the geographical area containing radio cells whose commissioning date belongs to a given time interval, over which the performed deployments are to be studied a posteriori.

For example, the evolution table TB_KPI_EV is built comprising several categories or groups of columns, among which:
Topography: the columns of this group form the primary key of the evolution table. This group contains the columns of the X and Y geographical coordinates of the location where the cells are located. Advantageously, it is possible to specify the considered sector in a dedicated column. For example, in the table, the columns X and Y correspond to longitude and latitude, and the sector column is described by the azimuth.
Added configuration: the number of columns in this group is equal to the number of frequency bands existing in the technology that can be deployed. For example, when 4G cells have been added during the learning period, the table includes as many columns as added special configurations (added 700 MHz, added 800 MHz, added 1,800 MHz, added 2,100 MHz, added 2,600 MHz).
Existing configuration: the number of columns in this group is equal to the number of frequency bands existing in the technology(s) the impact of deployment thereof is studied. For example, if it is desired to study the impact on the performances of 4 of the 5 existing 4G frequencies of the performed deployments, 4 columns relating to the 4 existing 4G frequencies (existing 800 MHz, existing 1,800 MHz, existing 2,100 MHz, existing 2,600 MHz) are provided.
KPIs by frequency before deployment: the columns in this group contain the values of the performance indicators KPI measured for the frequencies of the existing configuration before the deployment period. For example, in the table, the following three performance indicators have been taken into account: the use of PRBs (PRB avt 800 MHz, . . . , PRB avt 2,600 MHz), the number of users (Nb UT avt 800 MHz, . . . , Nb UT avt 2,600 MHz), and the number of PRBs/user (PPU avt 800 MHz, . . . , PPU avt 2,600 MHz).
KPIs by frequency after deployment: the columns of this group contain the values of the Key Performance Indicators (KPIs) of the frequencies of the existing configuration after deployment. Of course, there are as many columns in this group as in the previous group. For example, the table includes the 3 previous KPIs: the use of PRBs (PRB after 800 MHz, . . . , PRB after 2,600 MHz), the number of users (Nb UT after 800 MHz, . . . , Nb UT after 2,600), and the number of PRBs/user (PPU after 800, . . . , PPU after 2,600 MHz).
Growth of the KPIs (%): the columns of this group result from a growth rate calculation based on the columns of the groups of KPIs by frequency before deployment and KPIs by frequency after deployment.
For example, the calculation of the growth rate is direct, according to the following formula:

$$C r = \frac{{KPI}_{A p s} - {KPI}_{A v t}}{{KPI}_{A v t}} \qquad ( eq . 1 )$$

Where Cr denotes the growth rate, KPI_{Aps} the measurement of the performance indicator after deployment of the considered configuration and KPI_{Avt} the measurement of the performance indicator before deployment of the considered configuration. In some cases, it could be interesting to transform the KPIs before calculating the growth rate. For example, rather than calculating the growth of the usage rate of the PRBs, it is preferable to calculate the growth of the availability of the PRBs. Indeed, the pursued positive impact is the reduction in the use of the resources following the deployment of new radio cells. For the same deviation in the use of the PRBs, the availability rate is all the more important as the occupancy goes from a high level to a medium level than from a medium level to a low level.

The relationship between the availability and the percentage of usage of the PRBs is as follows:

D=100−PU(PRBs) (eq. 2)

Where D represents an availability rate of the PRBs and PU(PRBs) a percentage of usage of the PRBs.

For example, columns are provided in the evolution table to indicate the growth rate of the availability rate AGR (standing for “Availability Growing Rate”) of the PRBs (AGR 800, . . . , AGR 2600), the growth rate UGR (standing for “User Growing Rate”) of the number of users (UGR 800, . . . , UGR 2600), and the growth rate PPUGR of the number of PRBs/user (PPUGR aps 800, . . . , PPUGR aps 2600).

Time periods selected for the extraction of the data of the network relating to the deployed radio cells and for the calculation of the KPIs before/after deployment

The comparison of the values of the KPIs before/after deployment of new radio cells is not a trivial exercise as it is easily biased by external factors. If the KPIs of the previous month are simply compared with the month following deployment on a given site, it is possible that the seasonal variations influence the values of the KPI more than the candidate deployment itself. In this respect, mention may be made of the example of the summer period, marked by a strong geographical mobility with holidaymakers leaving their main residence. This phenomenon is very pronounced in the Paris region, where there a significant drop in mobile network traffic is noticed between June and the July/August period, followed by a renewed load in September, after returning to schools.

To reduce the effect of this seasonality type, one solution is to compare the KPI values of a given month M of the current year with the same month M of the next year. The assumption is that a given month experiences the same seasonality from one year to another. It is also assumed that the new configuration(s) have taken place during a deployment period inserted between the two successive occurrences of this month M. For illustration, FIG. 4 shows a chronology explaining the study intervals. During the months (MN−1, MN, with N=2022) that precede and follow the deployment period DP, performance indicator measurements are obtained before (KPI_{Avt}) and after deployment (KPI_{Aps}). There is a difference in traffic between the month M of the year N−1 and of the year N. It is assumed to be due at least in part to the user load distribution between existing cells and new cells, and for another part, this variability may be explained by the evolution of the number of subscribers of the operator over the considered time period.

### Control Set

It should be understood that a significant evolution in the number of subscribers of the operator could bias the results of the comparison of the KPI values before and after deployment of new resources. In order to be able to take this evolution into account, it may be interesting to use a “control” set of learning data, including only sites whose configuration has not evolved during the deployment period DP. A comparison of the KPI values for this control set would allow obtaining an indicative difference in the “natural” evolution of the mobile network over the observation period and which could be subtracted from that of the updated sites.

It should be noted that several constraints should be met for the compilation of such a control set, among which:
no deployment of cells on the site over the observation period, as well as in a neighborhood defined in advance. For example, in an urban area, it is possible to select a 1 km radius,
the geographical area of the sites of the control set should be included in that of the learning set. It is even possible to distinguish subsets of controls according to the urban fabric (industrial, residential, leisure neighborhood, transport areas, commercial areas, etc.) within the geographical area of the learning set. In this case, the selection of the control subset the evolution of which is to be subtracted should be the closest in terms of the topography of the updated site.

### Data Enhancement

It is well known that to successfully implement a machine learning technique, and build a powerful prediction model that is both accurate and generalizable, a large amount of learning data is needed over the longest possible observation period.

In this respect, there are several options for increasing the learning data.

It is possible to collect the KPI values at the cell sector level. Indeed, each site and therefore each cell has an average of three sectors, which allows tripling the size of the data set, for the same history,

It is also possible to shift an observation period by one month until no sufficient history is no longer available, and for each observation period, produce the table. For example, based on historical data from Jan. 1st, 2021 to Jun. 30th, 2022 (1 year and a half), it is possible to create six tables comparing the performance of:
January 2021 with January 2022
February 2021 with February 2022
. . . ,
June 2021 with June 2022.

This allows extending the observation period and approaching an ideal duration of around two years.

Data from the control set may also be added to the learning data set.

The longer the history of the data, the greater the number of deployment examples will be. The minimum is a one-year history, but the ideal size would be two years. For the data of the control set, the added configuration columns will all be null since nothing is deployed. However, it has been empirically observed that these sites could improve the generalization capacity of the predictive models.

Finally, it is possible to concatenate the obtained six evolution tables to form one single table T_KPI_EV. In case of duplicates (same topography and same configuration deployed on the same existing configuration), the data could be aggregated in one single row by applying the average or median function.

### Modeling (34) of the Service Coverage of Existing Sites (or Sectors) and Creation of a Table Describing The Topography of The Sites

To create a table describing the topography of the sites or of the sectors, it is necessary to know their service coverage. The latter may be determined by simulation software.

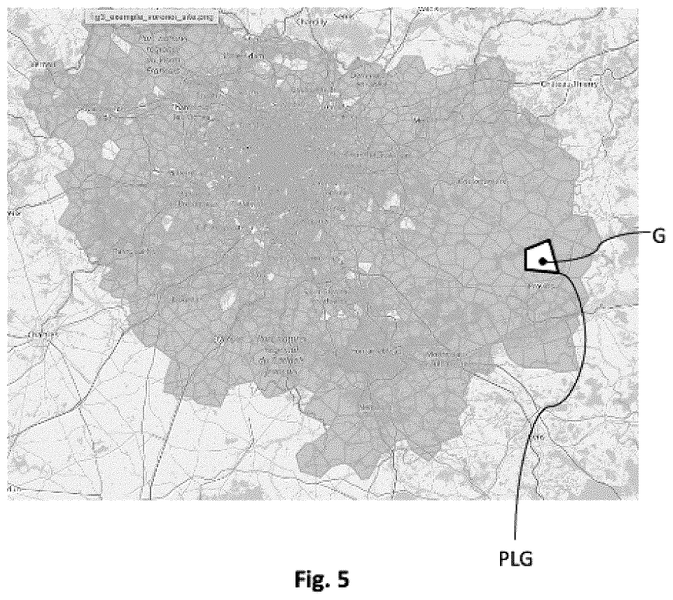

Alternatively, the service coverage of the sites (or of their sectors) for which the topographical information has been obtained beforehand, may be determined in 34 based on the Voronoi diagram. In the case where sites are studied, the diagram is used as is, using the geographical positions of the sites as germs. This results in polygons whose area represents the service coverage. For illustration, FIG. 5 shows an example of a map of the service coverage of the sites in a given geographical area. A polygon PLG centered on a germ G corresponding to the geographical coordinates of a site has been surrounded.

### Modeling of The Service Coverage of a Sector

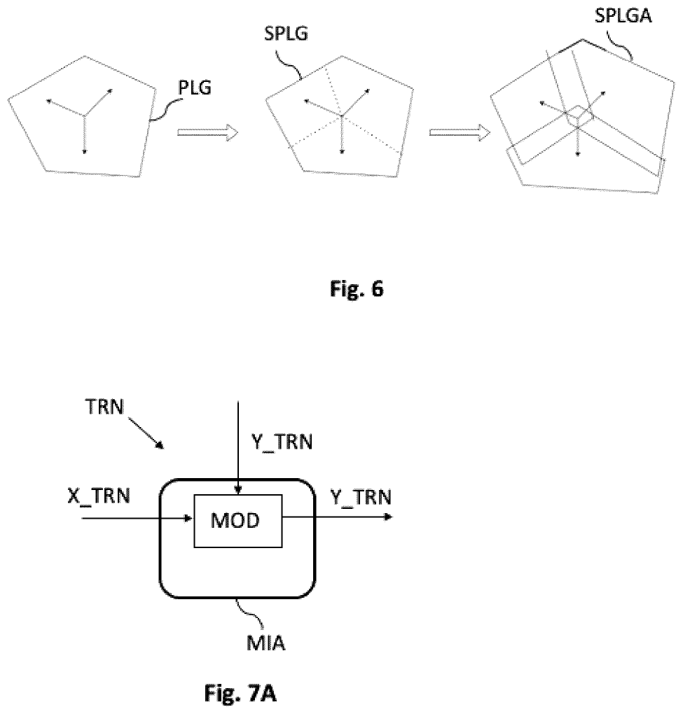

Alternatively, it is possible to model the service coverage of each of the sectors of the sites of the studied geographical area. This modeling subdivides the polygons of the Voronoi diagram associated with sites into sub-polygons SPLG associated with the sectors covered by these sites. Advantageously, it is possible to enlarge the polygons (SPLGA) to account for the overlapping of the coverage areas at the boundary of the sectors, as illustrated by the diagram of FIG. 6.

More specifically, splitting is done according to the bisectors between the azimuth directions of the antennas using geospatial functions provided by libraries. For example, it is possible to use Postgis functions (https://postgis.net/), an extension for the Po stgreS QL database system (https://www.postgresgl.org/).

Afterwards, to account for the coverage superposition at the boundary of the sectors, a scaling function is applied to enlarge the polygons. Empirically, a 1.5× enlargement allows for a good match between the radius of the circle encompassing the polygon and the average radius calculated based on the network data. The origin point of the enlargement may be the location of the site, or a point belonging in the azimuth direction of a sector.

### Creation of The Urban Fabric Covered by Each Existing Site (or Sector)

Based on the service coverage data obtained for the sites and/or the sectors of the studied geographical area, a table TB_TU representing the urban fabric covered by each site or sector is created in 35.

The columns of this table may be grouped together according to the following groups:

Topography: the columns of this group form the primary key of the table. It contains the columns of the X and Y geographical coordinates of the position of each site. If the study is done on a sector scale, a column is also added to identify it.

Mapping: Each column of this group quantifies the presence of a type of infrastructure, a land characteristic or use, a point of interest covered by the site or the sector. Depending on the considered aggregation type, it is possible, for example, to indicate whether an infrastructure is present or not, or to count its number or to calculate its total area. This group includes the area of the polygon corresponding to the modeled service coverage area.

Demographics, socio-economics: Each column of this group includes information on the population (number of inhabitants, for example, based on data from the “Humanitarian Data Exchange” database) or socio-economic data relating to the covered area (for example, derived from the gridded data (200 m-side squares) of the INSEE in 2017, relating to population income, poverty and the standard of living in France, accessible at the following link https://www.insee.fr/fr/statistiques/6215138?sommaire=6215217)).

### Data Aggregation Methods

Thus, the collected service coverage, map, demographic and socio-economic data are represented in tables indexed by geographical coordinates. Hence, it is possible to use geospatial functions to make a spatial connection between the service coverage and each data source.

For example, with the Postgresql's Postgis module, it is possible to make a spatial on the intersection condition between geometric objects representative of the service coverage and geometric objects describing the urban fabric.

Once joined, the data are aggregated at the site or sector level.

For example, the aggregation function for demographic and socio-economic data is the sum. For map data, the function may be the number of objects or the sum of the areas of these objects. In the case of OpenStreetMap, which is a heterogeneous database comprising point objects (points of interest) and polygons, the area of a point of interest is approximated to 1m2 to make the sum of the areas.

### Compilation of The Training Data Set for The Artificial Intelligence Module

Based on the table TB_KPI_EV of evolution of the performances of the sites/sectors and the table TB_TU of the urban fabric associated with each site/sector, the training data set LSET is compiled in 36 to build the prediction model MOD.

A first step consists in merging the two tables, by joining or indexing the columns of the topography group. Since some frequencies do not exist at some sites, the resulting table may contain unknown values. In this case, they are set to 0.

Afterwards, the resulting table is divided into four sets or sub-tables comprising:
a table X_TRN of variables which is presented at the input to the artificial intelligence module for training the prediction model MOD,
a table Y_TRN of variables which corresponds to the target values that the prediction model MOD should learn to predict, i.e. which should be produced at the output of the artificial intelligence module, during training on the input data X_TRN,
a table X_TST of variables which is presented at the input to the artificial intelligence module to evaluate the accuracy of the outputs of the trained model,
a table Y_TST of variables which corresponds to the target values associated with X_TST.

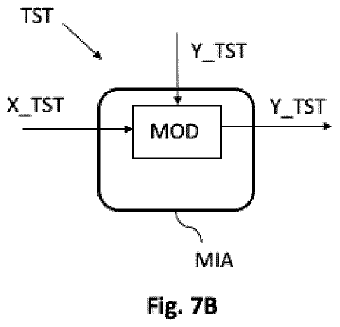

Referring to FIGS. 7A and 7B, the tables X.TRN, Y_TRN are used in a first step for training/learning (TRN, FIG. 7A) of the artificial intelligence module MIA and therefore building of the prediction model MOD, whereas the tables X_TST, Y_TST which comprise data that the prediction model MOD has never seen, are used in a second step to evaluate (TST, FIG. 7B) the prediction error of the prediction model MOD built based on the tables X_TRN, Y_TRN in a situation that approaches the closest the deployment of the solution in the production environment.

Thus, the variables included in the input tables X_TRN, X_TST are the columns of the groups added Configuration, existing Configuration, KPIs by frequency before deployment, mapping, demographics, socio-economics.

The variables included in the output tables Y_TRN, Y_TST are the columns of the group KPIs by frequency after deployment, or the group KPIs Growth. It has been empirically observed that the columns of the group KPI Growth were better predicted by carrying out the prediction on the group KPIs by frequency after deployment and then by calculating the growth rate.

Normalization of the data X_TRN, X_TST: the predictions may be improved, for example, by application of a so-called term frequency-inverse document frequency technique TF-IDF (standing for “term frequency-inverse document frequency”), for example described in the following link (https://en.wikipedia.org/wiki/TF-IDF) to weight the values in the columns. It is generally used in the study of text bodies, to reduce the word weight of a text whose values are overrepresented, for example by reducing the impact of articles such as “the” and, on the contrary, by increasing the impact of more specific names, by analyzing a number of occurrences of the words in the text.

In this case, it involves applying the TF-IDF technique to all columns containing topographical data, considering a type of geographical object as a word, and their number/sum of areas as a number of occurrences to rebalance the columns by weighting using coefficients derived from the TF-IDF technique. For example, this operation would reduce the impact of traffic lights present in large numbers, and increase that of fewer yet more relevant supermarkets in terms of socio-economic considerations.

### Method for Separating the Training and Test Data

The learning phase comprises a training of the prediction model followed by a test of the previously trained model, in order to verify in particular an accuracy of the output data it produces. To do so, it is possible to use conventional cross-validation methods like for example the so-called “K-fold clustering” technique to statistically estimate the error. Alternatively, the bootstrap technique may also be used.

As regards the sectors, it should be noted that to avoid any leakage of information between the training and test data, it is preferable to perform a separation by sites rather than by sectors, i.e. all sectors of the same site should belong either to the training set or to the test set.

### Selection of The Algorithm for Training The Prediction Model

The problem to be solved is a multi-target regression problem, since we are trying to predict several continuous values (one per frequency band and per KPI).

The training of the prediction model MOD depends on the algorithm selected for the artificial intelligence module MIA. Since the data are tabular, the current state of the art recommends the use of models based on decision trees, for example described in the document entitled “Tabular Data: Deep Learning is Not All You Need”, published in 2022, in the journal “Information Fusion”, volume 81, pages 84-90, ISSN 1566-2535, accessible at the following link https://arxiv.org/abs/2106.03253)

However, it cannot be excluded that neural networks based on deep learning techniques (“deep learning”) will become the best models for this area in the near future. Mention may be made of recent searches on networks of the transformer type (“Transformers”), “applied to tabular data (TabTransformer: Tabular Data Modeling Using Contextual Embedding s, https://arxiv.org/abs/2012.06678).

As regards the models based on decision trees, so-called “boosted gradient” models such as XGBoost (https://xgboost.ai/), Catboost (https://catboost.ai/) and LightGBM (https://lightgbm.readthedocs.io/en/v3.3.2/) compete for the first place depending on the problems to be solved.

Of course, other techniques may be used, including, yet without limitation: Support Vector Machines (SVM)/Support Vector Regressor (SVR), K-nearest neighbors (KNN), Random Forests.

Optimization: all of the aforementioned algorithms have hyperparameters. These are pre-selected parameters that influence the training and therefore the accuracy of the predictions. The selection of the hyperparameters can be optimized using known methods, like a comprehensive (“grid search”) or random search (“randomized search”) search, and which will not be described herein.

Output processing: as mentioned before, the input data table contained unknown values that have been set to 0. Hence, the output data of the model are processed by forcing to 0 the predictions obtained for cells corresponding to frequencies that do not exist among the sites of the learning set.

### Evaluation of The Error-Based Prediction Model

Based on the test data X_TST, Y_TST, the prediction model MOD may be evaluated in 38, for example based on:
the evaluation of the prediction error at the output of the artificial intelligence module, or
the evaluation of the prediction error on a ranking of the sites based on the estimated growth rate, when the evaluation method is applied to the arbitration between several candidate configurations.

Evaluation of the prediction error at the output of the prediction model MOD:

A typical metric for a regression problem is the root mean squared error RMSE (standing for “Root Mean Squared Error”):

$$RMSE = \sqrt{\frac{1}{n} {\sum }_{i = 0}^{n} {( {\hat{y}}_{i} - {y}_{i} )}^{2}} \qquad ( eq . 3 )$$

where n is the number of predicted sites/sectors, ŷi is the ith prediction and yi is the actual value.

The error RMSE is expressed in the same unit as the predicted value. However, it should be noted that this error depends on an absolute difference. Hence, it is not very well suited to our problem including data with quite variable scales.

Hence, another metric to consider is the SMAPE error (standing for “Symetric Mean Absolute Percentage Error”), based on relative differences (percentages):

$$SMAPE = \frac{1}{n} {\sum }_{i = 1}^{n} \frac{\vert {\hat{y}}_{i} - {y}_{i} \vert}{⌈ {y}_{i} ⌉ + \vert {\hat{y}}_{i} \vert} \qquad ( eq . 4 )$$

This metric normalizes the error between 0 and 1.

Regardless of which metric is used, the prediction model selected from a set of prediction models is that one which corresponds to the lowest error value.

### Evaluation of The Prediction Error in Ranking The Sites Based on The Estimated Growth Rate

The previous evaluation, based on an error measurement, is a direct evaluation of the performances. However, it does not say much about the usefulness of the obtained prediction model. The Inventors have studied the possibility of evaluating the prediction models based on use cases of these models.

For example, an application of the development to the prioritization of sites to be deployed is considered. In this context, it is relevant to evaluate a model based on the ranking of the sites it produces.

A possible protocol is as follows:
1. Random selection of n sites/sectors in the test set;
2. Prediction of the performance indicators KPIs after known historical deployments;
3. Calculation of an evolution rate of the KPIs;
4. Calculation of a score by aggregating the rates of evolution of all frequencies;
5. Evaluation of the predicted scores with regards to actual scores;
6. Reiteration of the previous steps to obtain a statistical evaluation.

### Calculation of The Score Associated with The Deployment of a Configuration on a Site

For example, the following score values are assigned to a cell of this site:
0: if the evolution is negative,
1: if the evolution is zero, or if the frequency does not exist,
2: if the evolution is positive.

For example, if a configuration site {800 MHz, 1,800 MHz, 2,600 MHz} obtains a rate of evolution of its performance indicators {2%, 0%, −0.5%}, then the score of the frequencies is {2, 1, 1, 0}. It should be noted that the additional score 1 is assigned to the frequency 2,100 MHz which is not present. Thus, the cell 2,100 MHz that is not present is considered as a cell that has not evolved.

Afterwards, the score of the site is calculated as the average of the scores of the cells. In the previous example, it is 1.

For example, for 4G technology cells the evolution of the frequency bands 800 MHz, 1,800 MHz, 2,100 MHz and 2,600 MHz of which is studied, it is possible to consider that a site having obtained a score strictly higher than 1 as a site whose overall evolution is positive. On the contrary, a site associated with a score strictly below 1 is a site whose overall evolution is negative. A site having obtained a score equal to 1 has not generally evolved in terms of performances.

In this respect, a generally negative development of the sites is often noted despite an update. This could be explained by the fact that the evolution of a site is also influenced in part by that of the subscribed user pool and their consumption. It would even be possible to consider selecting sites whose score is the lowest in the obtained ranking for a future deployment, assuming that these are the sites with the greatest need for capacity increase. In this case, all it needs is to change the method of assigning scores, for example by reversing the criteria.

### Score Variant by Site or Sector Frequency, Usable in Both Training and Production (for The Actual Prediction of a Variation in The Performance Indicators)

Alternatively, the scores are calculated as follows:

$${SC}_{k} = \{ \begin{matrix}0 & {GR}_{k} < 0 \\ 1 & {GR}_{k} = 0 if the frequency does not exist \\ \frac{2}{1 + {e}^{- {GR}_{k}}} & {GR}_{k} > 0\end{matrix} \qquad ( eq . 5 )$$

### Where:

SCk is the score of the frequency (or cell) k of a given site/sector,
GRk is the predicted growth rate of the KPI.

One advantage of this variant is that the obtained score tends towards 2 when the predicted growth rate GRk goes towards infinity, which allows differentiating the positive rates while limiting the values taken by the score SCk.

The overall score of the site may be obtained by calculating the average of the scores of the cells k that make it up:

$$SC ( STi ) = \frac{1}{n} {\sum }_{k = 1}^{n} S {C}_{k} \qquad ( eq . 6 )$$

Alternatively, it is possible to simply add up the scores of the cells of the site.

### Metrics to Evaluate The Scores

For example, metrics that are commonly used in information searches are used. Considering a ranking of n elements, the k-th position of the ranking is called the rank k. For example, consider a metric of the reciprocal type RR (“Reciprocal Rank”), known per se, which is in the following form:

$$RR = {\sum }_{k = 1}^{n} \frac{1}{k} rel ( k ) , \qquad ( eq . 7 )$$

Where rel(k) is 1 in the rank where the score is the highest, and 0 anywhere else.

Alternatively, an average precision metric AP (standing for “Average Precision”) is used, which is expressed as follows:

$$AP = \frac{{\sum }_{I = 1}^{n} ( P ( k ) . rel ( k ) )}{NPE} \qquad ( eq . 8 )$$

### Where:

rel(k) is 1 if the score of a site is strictly higher than an arbitrarily selected threshold, 0 otherwise;
P(k) is the accuracy at the k-th rank of the classification.

For example, a threshold of 1 means that only sites with a score strictly above 1 are considered to be sites relevant for deployment. It should be noted that a good model is a model that will rank such sites at the top of the ranking.

A less stringent threshold may also be selected depending on the reality on the ground.

According to another variant, a gain value is evaluated, for example of the actualized cumulative type NDCG (standing for “Normalized Discounted Cumulative Gain”).

$$n D C {G}_{k} = \frac{D C {G}_{k}}{IDC {G}_{k}} \qquad ( eq . 9 )$$

$$Where :$$

$${DCG}_{k} = {\sum }_{i = 1}^{k} \frac{{rel}_{i}}{{log}_{2} ( i + 1 )} \qquad ( eq . 10 )$$

{1, . . . , k} is the ranking order up to the rank k according to the score based on the predictions of the model, relᵢ the actual score,
Since DCGk is not bounded, we divide by IDCGk, which is the score obtained for a perfect ranking.

Hence, this metric is normalized between 0 and 1.

In a statistical approach, these different scores are averaged over several rankings, to obtain a mean reciprocal rank MRR (standing for “Mean Reciprocal Rank”), a mean average precision MAP (standing for “Mean Average Precision”) and a mean average gain MNDCG (standing for “Mean Normalized Discounted Cumulative Gain”).

Once the best prediction model has been obtained, it can be deployed in a real-life situation, i.e. it can be used to evaluate a candidate configuration of a site of a communication network according to the method of the development described with reference to FIG. 2.

An application example of the method according to the development to evaluate candidate configurations is now detailed with reference to FIG. 8. For example, these configurations concern the 5 sites ST1-ST5 of the communication network shown in FIG. 1.

As for the training phase, in 80, 81 (step 20 of obtaining historical network data DRH of FIG. 2), performance indicator values KPI_PRC and topographical information I_TPO of the existing sites ST1-ST5 for the network RAN are obtained for a reference time period and external demographic, mapping and advantageously socio-economic data in a geographical area ZG comprising the sites ST1-ST5. In 82, a table of the performance indicators TB_KPI_PRC is created, based on the performance indicator values KPI_PRC. In 83, the coverage areas of the sites ST1-ST5 are modeled in the considered geographical area ZG, as described before, and a table TB_TU_H of the urban fabric associated with the sites ST1-ST5 in these coverage areas is built in 84, based on the contextual external data DEXT.

It should be noted that the structure of the table of the urban fabric TB_TU_H is the same as that described before for the learning set. However, in 82, a performance table TB_KPI_H is built herein instead of a performance evolution table, since we rely only on historical data, prior to a future deployment.

### Creation of The Table of the Performances of The Sites (or Sectors)

The table of the performances of the sites/sectors represents the current state of the network. The columns in this table form a subset of the columns of the previously-described performance evolution table TB_KPI_EV.

Nonetheless, groups of data already present in the evolution table TB_KPI_EV are found:

Topography: the columns in this group form the primary key of the table. It contains the columns of the X and Y geographical coordinate of the position of the sites ST1-ST5. If the study is done on a sector scale, a column is also added to identify it.

Existing configuration: the number of columns in this group is equal to the number of existing frequency bands in the technology(s) whose deployment impact is studied. It should be understood that there are potentially more cells than already deployed on a given site STi. For example, in table 1, we decide to study the impact of the deployment of candidate configurations on 4 of the 5 4G frequencies in service, therefore there are 4 columns (existing 800 MHz, existing 1,800 MHz, existing 2,100 MHz, existing 2,600 MHz).

KPIs by frequency before deployment: the columns of this group contain the values of the KPIs obtained for the frequencies of the cells of the current existing configuration, over a recent reference sub-period (for example 1 month).

For example, the performance table TBKPIH comprises three distinct performance indicators: the use of the PRBs (PRB before 800 MHz, . . . , PRB before 2,600 MHz), the number of users (NB UT before 800 MHz, . . . , NB UT before 2,600 MHz), and the number of PRB s/user (PPU before 800 MHz, . . . , PPU before 2,600 MHz).

### Table Describing The Topography of The Scheduled Deployments on The Sites (or Sectors)

This table TBTPOCND is made up of the same columns as that of the “Added configuration” group already described in connection with building of the evolution table TB_KPI_EV. A notable difference lies in the fact that it is up to the operator to enter the deployments he is considering, whereas in the evolution table, these topographic data were part of the historical data (since they relate to configurations already deployed).

Configuration to deploy: the number of columns in this group is equal to the number of frequency bands existing in the technology that can be deployed.

For example, when adding 4G cells, it includes 5 columns (added 700 MHz, added 800 MHz, added 1,800 MHz, added 2,100 MHz, added 2,600 MHz).

It should be noted that the development also allows evaluating the addition of cells implementing another technology, for example 5G, and/or the reuse of 4G frequencies for 5G, which corresponds to a reorganization of the site (“refarming”). Of course, the artificial intelligence module MIA should have been trained beforehand to predict the impact of this deployment type on the performances of the network.

### Compilation of The Input Data Set INP_SET for Predicting an Evolution of The Kpis by The Model MOD of The Artificial Intelligence Module

The method for compiling the dataset to be presented at the input of the predictive model is the same as that one described before for the training phase of the prediction model MOD, with the difference that only one is created. Indeed, it is not herein necessary to provide for a training and test set, and the values describing the actual post-deployment evolution are not available.

Merging the data sets: The three tables of site/sector performances, scheduled deployment topography and urban fabric associated with each site/sector are merged by joining the columns of the topography group. Since some frequencies do not exist on some sites, the data table INP_SET corresponding to the input data set may contain unknown values, which are set to 0 in this case. In this example, the table INP_SET comprises 5 rows (one per site STi, with I an integer comprised between 1 and 5).

Thus, the variables kept in INP_SET are the Columns of the Configuration groups to be deployed, existing configuration, KPIs by frequency before deployment, mapping, demographics, socio-economics.

Normalization of the data in the table INP_SET: the predictions may be improved, for example, by applying a technique TF_IDF so-called the term frequency-inverse document frequency technique (“term frequency-inverse document frequency”), to weight the values in the columns.

It should be noted that, in the example that has just been described, the collected historical network data concerns only sites on which the deployment of candidate configurations is considered. Nevertheless, the development is not limited to this example. In another embodiment of the development, particularly suitable for less dense or rural areas, the study of the impact of the deployment of new cells is extended to neighboring sites. To do so, at least one additional topographical information should be taken into account, which is the geodetic distance between the site where the deployment of a configuration is considered (or has been done for the learning data), and the neighboring site.

Furthermore, if the candidate configuration concerns a new site that did not exist before deployment, then it is also necessary to add a column for a piece of information, for example with a binary value, indicating whether the site existed (1) before deployment or not (0).

In the row of the table INP_SET, the existing configuration then corresponds to that of the affected neighboring site and the configuration added to that deployed on the updated or created site.

### Prediction of The Performances of The Existing Cells

The table INP_SET obtained in 85 is presented at the input of the trained and tested artificial intelligence module MIA.

Depending on the performed training, the prediction model MOD implemented by this module produces in 86 one output per site or sector. Each of these outputs is composed of several variables resulting either from an estimate of the KPIs after deployment, or from an estimate of a rate of evolution of the KPIs between before and after deployment.

The output format is the same as for the targets Y_TST described in connection with the learning phase.

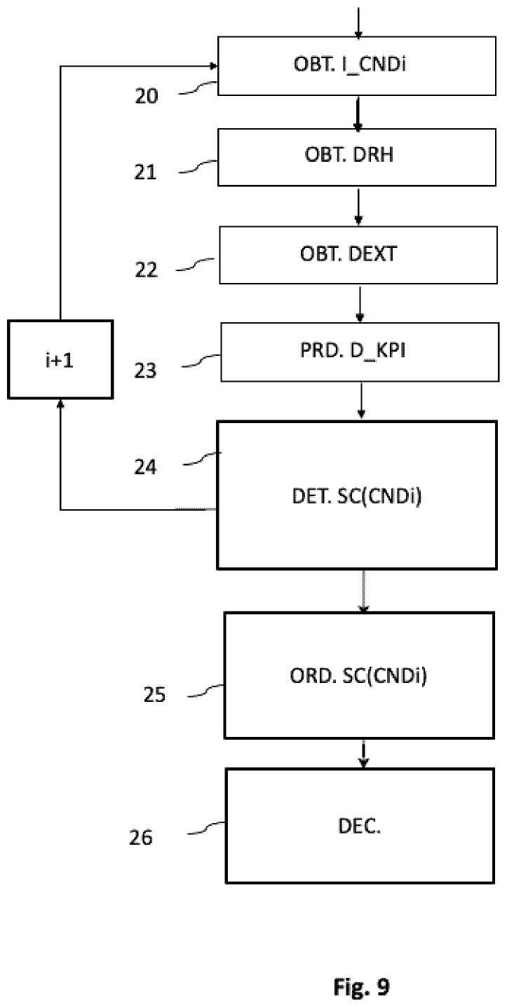

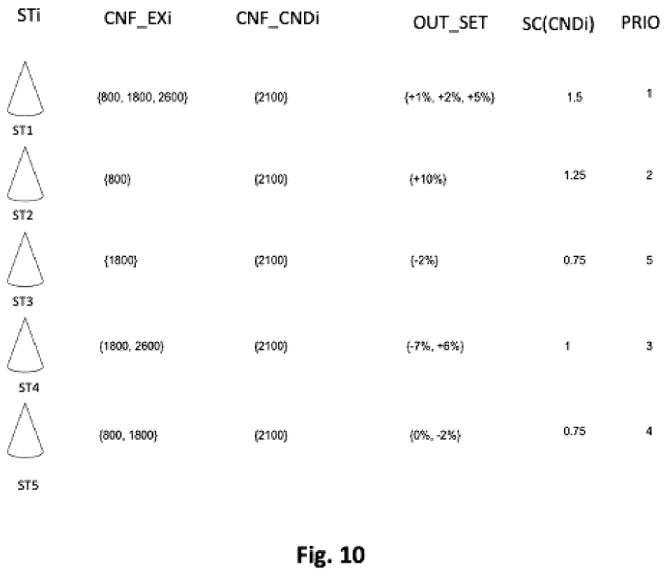

Referring to FIGS. 9 and 10, an embodiment is now described according to which the evaluation method that has just been described is applied to arbitration between several candidate configurations. As example, the 5 sites ST1-ST5 of FIG. 1 are considered. Of course, the development is not limited to this example and would apply to a larger number of candidate sites. In this respect, it should be noted that the use of the previously-described metrics for evaluating the scores could be adapted according to this number. For example, to rank 5 sites, the metric NDCG is used at the rank k=5, but to rank 50 sites, we could stop at the rank k=1 and thus evaluate only the accuracy of the scores of the 10 best scores obtained.

Afterwards, each candidate configuration CNDi is evaluated, with i comprised between 1 and 5, by implementing the steps of the method that has just been described. In this example, the historical network data is collected for the radio cells already installed on the candidate sites ST1-ST5.

In 24, a score Sci is obtained for the site STi. To do so, steps 20-24 may be implemented iteratively to sequentially process the candidate configuration CNDi of each site STi or alternatively, all candidate configurations are evaluated simultaneously.

### Ranking of The Deployments to be Carried out Based on The Predicted Evolutions

An overall score Sci for each site/candidate sector STi is calculated in 24 according to the values of KPIs or the rate of evolution of KPIs produced at the output of the artificial intelligence module. Preferably, this overall score is defined in the same manner as that used during the training phase since we know the accuracy of the model thereon.

Afterwards, the candidate sites/areas are ranked in 25 in a descending order of score.

### Prioritization of the Deployments According to The Ranking Order

This obtained ranking suggests the deployment order of the sites/sectors the most advantageous for the operator in terms of:
improvement of the quality of service (bit rate, resources/user), and/or
decrease in the network load, and/or
prioritization of the most loaded or solicited sites (according to the selected score function).

This prioritization is translated in terms of criteria PC which are taken into consideration to calculate the overall score SC(CNDi) in 24 based on the predictions obtained by the artificial intelligence module in 23. The score is calculated as described for the training phase.

Optionally, the obtained ranking is used in 25 to decide in 26 of at least one configuration to deploy, the first one of the ranking obtained in 24.

Referring to FIG. 10, the ranking obtained for the 5 candidate sites is presented in FIG. 1. FIG. 10 shows a table comprising for each site information relating to the existing configuration (in the column CNF_EXI), information relating to the candidate configuration (in the column CF_CNDi). It also shows in a next column (OUT_SET) the evolution rates of three obtained performance indicators predicted by the artificial intelligence module. These are the three KPIs presented hereinabove. The table then comprises a column relating to a score SC assigned to each candidate configuration based on the evolution rates of the previous column and prioritization criteria CP. Finally, it comprises a column PRIO comprising a ranking order of each site deducted from the score SC obtained by each site. In this example, the site that has obtained the highest score is ranked first.

Thus, the operator of the mobile network RM can use this table to decide on the most relevant deployments to implement.

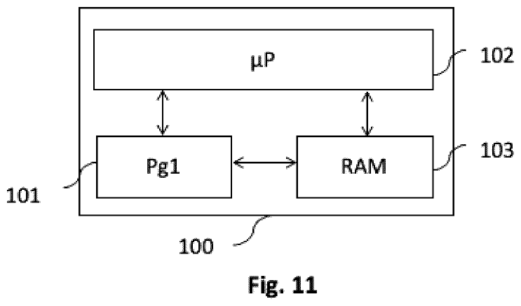

Finally, referring to FIG. 11, an example of a hardware structure of a device 100 for evaluating at least one candidate configuration of radio access equipment of a communication network, said device comprising a module for obtaining data, so-called the historical data, relating to said network in a geographical area comprising a geographical location of the radio access equipment, so-called the site, is presented, said historical data comprising at least topographical information relating to sites existing in said geographical area before deployment, and measurements of at least one performance indicator of the communication network in the geographical area during an elapsed time period, so-called the reference period, and a module for determining a metric for evaluating said candidate deployment, or score, according to a variation in said at least one performance indicator of the communication network in said geographical area, induced by said deployment and at least one prioritization criterion associated with a metric representative of an evolution of a performance of the network induced by said deployment, said variation being predicted from the historical data and topographical information relating to the candidate configuration.

Advantageously, the device 100 further comprises a module for predicting the variation of said at least one performance indicator of the site following the deployment, from a previously learned prediction model, said prediction model being implemented by an artificial intelligence module configured to receive as input the historical data and the topographical information of the candidate deployment and produce the variation of said at least one output performance indicator, the score being obtained by applying said at least one prioritization criterion to the predicted variation.

Advantageously, the device 100 comprises a module for obtaining external data in the geographical area comprising demographic and map data of the geographical area, a module for modeling a geographical area served by said at least one site, so-called the radio coverage area (ZC), from said historical network data and the historical external data (DEXT).

Advantageously, the device 100 comprises a module for building, based on the historical external data obtained in the radio coverage area, a second data table, called urban fabric of the coverage area of the site.

Advantageously, the device 100 is configured to evaluate a plurality of candidate configurations and comprises a module for ranking the plurality of deployments according to the determined scores.

The term “module” may correspond to both a software component and a hardware component or a set of hardware and software components, a software component itself corresponding to one or more computer program(s) or sub-program(s), or more generally to any element of a program capable of implementing a function or a set of functions.

More generally, such a device 100 comprises a random-access memory 103 (for example a RAM memory), a processing unit 102 equipped for example with a processor, and controlled by a computer program Pg1, representative of the obtainment, prediction and decision modules, stored in a read-only memory 101 (for example a ROM memory or a hard disk). Upon initialization, for example, the code instructions of the computer program are loaded into the random-access memory 103 before being executed by the processor of the processing unit 102. The RAM 103 may also contain, for example, the obtained demographic and map information, the historical information relating to the network, the learned prediction model, the determined score, etc.

FIG. 11 illustrates only a particular manner, amongst several possible ones, for making the device 100 so that it performs the steps of the method as detailed hereinabove, with reference to FIGS. 2 to 9, in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates like an FPGA or an ASIC, or any other hardware module).

In the case where the device 100 is made with a reprogrammable computing machine, the corresponding program (i.e. the sequence of instructions) could be stored in a removable storage medium (such as an SD card, a USB flash drive, a CD-ROM or a DVD-ROM) or not, this storage medium being partially or totally readable by a computer or a processor.

The different embodiments have been described hereinabove in connection with a device 100 integrated into a mobile telecommunications network management equipment.

The development just described has many advantages. Indeed, it provides a method for evaluating the deployments of candidate configurations of radio access resources on existing sites or new sites of a communication network. This method is based on a calculation of evolution indicators of the network while limiting seasonality effects, training prediction models to learn to predict these indicators based on network, map and socio-economic data. It can be used by the technical and/or geomarketing teams of an operator to arbitrate and prioritize the locations of new deployments according to the predicted positive or negative impact.

1. A method for evaluating a deployment of a candidate configuration, of at least one radio access equipment of a communication network at a location, referred to as a site, in a geographical area wherein the method comprises:
obtaining network data, referred to as historical data, relating to the network in the geographical area, the historical data comprising at least topographical information relating to radio access equipment existing in the geographical area before the deployment of the candidate configuration at the location level, referred to as sites, and measurements of at least one performance indicator of the communication network in the geographical area during an elapsed time period, referred to as a reference period; and
predicting a variation of the at least one performance indicator of the communication network in the geographical area, induced by the deployment, the variation being predicted at least from the historical network data and topographical information relating to the candidate configuration, and from a previously learned prediction model, the prediction model being implemented by an artificial intelligence module configured to receive as input data the historical network data and the topographical information of the candidate configuration and produce as output data the variation of the at least one performance indicator.

2. The evaluation method according to claim 1, it wherein the method comprises:
determining a metric for evaluating the candidate configuration, or score, according to the variation and at least one prioritization criterion associated with a metric representative of an evolution of a performance of the network induced by the deployment,
the score being obtained by applying the at least one prioritization criterion to the predicted variation of the performance indicator.

3. The method according to claim 1, wherein the method comprises:
building based on the historical network data, a data table, called a performance table of the network in the geographical area;
building an input data table intended to be presented to the artificial intelligence module, based on the performance table, the topographic data relating to the candidate configuration and historical external data comprising demographic and map data of the geographical area;
an output data table being produced by the artificial intelligence module, comprising at least predicted values of the variation of the at least one performance indicator of the site induced by the deployment of the candidate configuration.

4. The method according to claim 3, wherein the method comprises:
obtaining the historical external data; and
modeling a geographical area served by the at least one site, referred to as a radio coverage area, based on the historical network data and the historical external data,
the radio coverage area of the at least one site being taken into account for the determination of an evaluation of the deployment of the candidate configuration.

5. The method according to claim 4, wherein the method comprises building, based on the historical external data obtained in the radio coverage area, a second data table, called urban fabric of the coverage area of the site,
the input data table being built by merging the performance table, the topographic data relating to the candidate configuration and the urban fabric table.

6. The method according to claim 1, wherein the method comprises, in a prior phase:
obtaining learning network data, relating to at least one site of a communication network in a geographical area, over an elapsed time period, referred to as a learning period, during which at least one new configuration has been deployed on the at least one site, the learning network data comprising at least topographical information relating to a previous configuration and to the new configuration of the at least one site and the measurements of at least one performance indicator of the site;
building based on the learning network data, a first data table, called the site's performance evolution table before and after the deployment of the at least one new configuration;
obtaining external learning data comprising demographic and map data of the geographical area, for the learning period;
modeling a geographical area of a geographical area served by the at least one site, referred to as a learning radio coverage area, from the learning network data;
building, based on the external learning data in the learning radio coverage area, a second data table, called the learning urban fabric table of the coverage area of the site;
building a first set of learning data by merging the performance evolution table and the learning urban fabric table; and
training the artificial intelligence module based on the first learning set, the prediction model being obtained.

7. The method according to the preceding claim 6, wherein the learning period comprises at least one first comparison period, one deployment period subsequent to the first period and a second comparison period subsequent to the deployment period and in that building of the performance evolution table comprises a comparison of the values of the at least one performance indicator obtained during the first and second comparison periods.

8. The method according to claim 7, wherein the method comprises
building a second set of learning data, referred to as a control set, obtained from learning network data for at least one other site of the network or of another network belonging to the same geographical area and for which no new configuration has been deployed during the learning period, and in that the artificial intelligence module is trained based on the first and second sets of learning data.

9. The method according to claim 2, wherein the method is implemented for a plurality of candidate configurations in the communication network and in that it further comprises ranking the plurality of deployments according to the determined scores.

10. The method according to claim 1, wherein, the site comprising at least one radio cell configured to transmit and receive radio waves at a given frequency in at least one given sector, the at least one candidate configuration belongs to a group comprising at least:
adding a radio cell associated with a frequency distinct from the frequencies existing at the site;
adding a transmission sector to an existing radio cell,
replacing an existing radio cell associated with a first frequency with a new radio cell associated with a second frequency distinct from the first,
replacing a radio cell associated with a first technology with a radio cell associated with a second technology.

11. A device for evaluating a deployment of a candidate configuration, of at least one radio access equipment of a communication network at a location, referred to as a site, in a geographical area, wherein the device is configured to:
obtain network data, so-called the historical data, relating to the network in the geographical area, the historical data comprising at least topographical information relating to radio access equipment existing in the geographical area before deployment of the candidate configuration at the location level, referred to as sites, and measurements of at least one performance indicator of the communication network in the geographical area over an elapsed time period, referred to as a reference period; and
predict a variation of the at least one performance indicator of the communication network in the geographical area, induced by the deployment, the variation being predicted at least from the historical network data and topographical information relating to the candidate configuration, and from a previously learned prediction model, the prediction model being implemented by an artificial intelligence module configured to receive as input data the historical network data and the topographical information of the candidate configuration and produce as output data the variation of the at least one performance indicator.

12. A telecommunications network management system, wherein the system comprises a device for evaluating a deployment of a candidate configuration of radio access equipment of a communication network according to claim 11.

13. A processing circuit comprising a processor and a memory, the memory storing program code instructions of a computer program for executing the method according to claim 1, when the computer program is executed by the processor.
